(19) United States
(12) Patent Application Publication
(10) Pub. No.: US 2005/0251936 A1
(43) Pub. Date: Nov. 17, 2005

(54) APPARATUS AND METHOD FOR CLEANING ELECTRONIC ARTICLES

(75) Inventor: Paul A. Manfredi, Waterbury Center, VT (US)

Correspondence Address: DOWNS RACHLIN MARTIN PLLC, 199 MAIN STREET, P O BOX 190, BURLINGTON, VT, 05402-0190, US

(73) Assignee: INTERNATIONAL BUSINESS MACHINES CORPORATION, Armonk, NY (US)

(21) Appl. No.: 10/709,574

(22) Filed: May 14, 2004

(51) Int. Cl. B08B 6/00

(52) U.S. Cl. 15/1.51

(57) ABSTRACT

A cleaning apparatus (20, 200) that includes a conductive path (84, 208, 212) from an article (24, 216) being cleaned to a ground (88, 220). The conductive path allows a static electrical charge present on the article to be drawn off the article so as to reduce the likelihood the article will be damaged by the static electrical charge. In one embodiment, the electrical path includes an electrically conductive brush (36). In another embodiment, the electrical path includes at least one contact (224, 228) spaced from a cleaning member.

### BACKGROUND OF INVENTION

1. Field of the Invention

The present invention generally relates to the field of electronics. In particular, the present invention is directed to an apparatus and method for cleaning electronic articles.

2. Background of the Invention

During the manufacture of electronic articles, e.g., semi-conductor wafers, magnetic storage disks and flat panel displays, the articles often become contaminated with various materials, such as particles, mobile ions and trace metals, among others, that are remnants of the various processes used to make the articles or are otherwise present in the manufacturing environment. Semiconductor wafers containing integrated circuits are particularly susceptible to damage from contamination. For example, particulate contamination present on the surface of a wafer during formation of a new layer can cause electrical opens or shorts in the various electrical components that form the integrated circuits. These opens and shorts can cause functional and reliability problems in the affected integrated circuits and, thus, lead to lower device yields than are desirable. The presence of mobile ions and trace metals can also lead to functional and reliability problems that ultimately reduce device yields.

Electronic articles are often cleaned between processing steps so as to minimize damage to the articles by contaminants. For example, relative to semiconductor wafers, depending upon the process performed on the wafer immediately prior to cleaning, the wafer may be cleaned using a wafer scrubbing system. Wafer scrubbing systems are available in a variety of types. For example, one type of wafer scrubbing system utilizes one or more cylindrical scrub brushes that are rotated about their longitudinal axes as one of the wafer and/or brush(es) are moved relative to one another while the wafer is contacting the brush(es), often in the presence of a cleaning solution. Other types of wafer scrubbing systems utilize disk-shaped brushes that are rotated about their concentric centers and/or oscillated in a plane perpendicular to their rotational axes.

A problem that has been experienced in wafer scrubbing systems is the presence of static electrical charges on the wafers during scrubbing. In some cases, these charges are of such a magnitude that some of the integrated circuit components aboard the wafers are damaged, thereby reducing the device yield of these wafers. What is needed is a means for reducing or eliminating static electrical charges on wafers as they are being scrubbed.

### SUMMARY OF INVENTION

In one aspect, the present invention is directed to an apparatus for removing contaminants from a surface of an article that may have a static electrical charge thereon, the apparatus being operatively configured for electrically connecting to an electrical ground. The apparatus comprises a cleaning member operatively configured to remove at least some of the contaminants. An electrically conductive path extends from the article to the ground when the apparatus is connected to the electrical ground.

In another aspect, the present invention is directed to a method of removing contaminants from a surface of an article that may have a static electrical charge thereon, comprising the step of cleaning the surface of the article with a cleaning member so as to remove at least some of the contaminants. During at least part of the time that the step of cleaning the surface of the article with a cleaning member is performed, the article is contacted with a conductive member connected to an electrical ground.

### BRIEF DESCRIPTION OF DRAWINGS

For the purpose of illustrating the invention, the drawings show forms of the invention that are presently preferred. However, it should be understood that the present invention is not limited to the precise arrangements and instrumentalities shown in the drawings, wherein:

FIG. 1 is a partial plan view/partial high-level schematic diagram of a cleaning apparatus of the present invention that includes an electrically-conductive cleaning member;

FIG. 2 is a cross-sectional view of the cleaning apparatus as taken along line 2-2 of FIG. 1;

FIG. 3 is a partial plan view/partial high-level schematic diagram of an alternative cleaning apparatus of the present invention that includes an electrical conductor spaced from the cleaning member; and

FIG. 4 is a cross-sectional view of the cleaning apparatus of FIG. 3 as taken along line 4-4 of FIG. 3.

### DETAILED DESCRIPTION

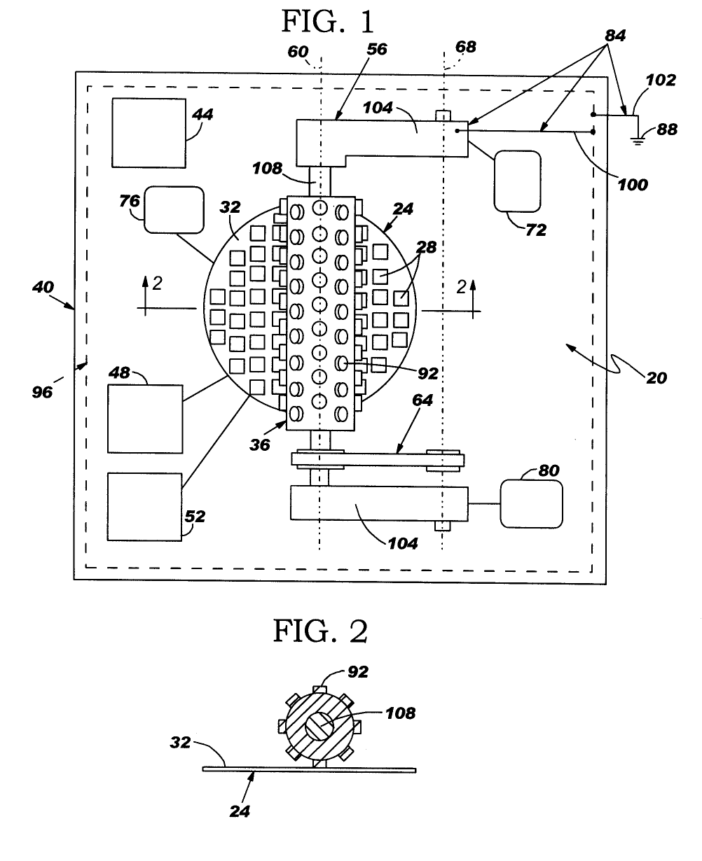

Referring now to the drawings, FIGS. 1 and 2 show in accordance with the present invention a cleaning apparatus, which is indicated generally by the numeral 20. Cleaning apparatus 20 may be used to clean one or more articles 24, e.g., an electronic article such as a semiconductor wafer having a plurality of integrated circuits 28 formed therein, so as to remove one or more contaminants (not shown) that may be present on one or more surfaces 32 of each article. Other types of articles 24 that may be cleaned using cleaning apparatus 20 of the present invention include magnetic storage disks and flat panel displays, among many others. Those skilled in the art will understand the variety of articles 24 that may be cleaned using cleaning apparatus 20 such that an exhaustive list is not necessary for those skilled in the art to appreciate the broad scope and applicability of the present invention.

As discussed in the background section above, contaminants may include, but are not limited to, particles, mobile ions, trace metals that are remnants of one or more processes performed on article 24 or are otherwise introduced to the article from environmental sources during manufacture of the article. In this connection, cleaning apparatus 20 may include at least one brush 36 that effects or aids the removal of at least some of the contaminants present on article 24 during cleaning. Cleaning apparatus 20 may be part of an overall cleaning system 40 that may include multiple ones of the cleaning apparatus or other cleaning apparatuses and other systems, such as a cleaning solution dispensing system 44, an article heating system 48, and an article drying system 52, among others. In addition, cleaning apparatus 20 may be modified in various ways, such as by providing several brushes for cleaning several sides of article 24 simultaneously or in seriatim and/or providing brushes capable of cleaning several articles at once, among others. Such modifications will be understood by those skilled in the art and, therefore, need not be enumerated and described in detail herein.

Brush 36 may be mounted on a brush support 56 that supports the brush and permits the brush to be rotated about its longitudinal axis 60, e.g., by a brush rotating system 64, such as the belt-drive system shown. Other suitable brush rotating systems 64 include geared systems and direct-drive systems, among others. Brush support 56 may be pivotable about a pivot axis 68 by a pivoting system 72 for such purposes as pivoting brush 36 into and out of contact with article 24 and/or varying the pressure applied between article 24 and the brush.

Brush support 56 may be movable or stationary, depending on the particular design of cleaning apparatus 20. Likewise, article 24 may be movable or stationary, again depending upon the particular design of cleaning apparatus 20. If brush support 56 is stationary, an article-moving system 76 may be provided to move article 24 relative to brush 36 so as to effect cleaning of entire surface 32 desired to be cleaned. If brush support 56 is movable, a brush support moving system 80 may be provided. Of course, each of brush support 56 and article 24 may be separately movable if desired by providing both article moving and brush support systems 76, 80. Although cylindrical rotational brush 36 is shown, other types of cleaning members may be used in addition to or in lieu of this brush. Examples of other cleaning members include another type of brush, a pad or other type of device.

As mentioned in the background section above, article 24 may have a static electrical charge thereon that can be detrimental to the article, and/or component(s) thereof, such as integrated circuits 28. Therefore, cleaning apparatus 20 further includes a conductive path 84 that extends from article 24 to an electrical ground 88 that provides a relatively low potential relative to the potential of the static electrical charge on the article such that at least a portion of the static charge is drawn from the article to the ground. When the cleaning member of cleaning apparatus 20 is of the contact type that contacts article 24 to effect cleaning, such as brush 36, the cleaning member may comprise an electrically conductive material so that it may be part of conductive path 84.

For example, in the context of brush 36, the brush may be made of a polymer that includes a conductive filler, such as graphite, among others. One suitable polymer is perfluoroalkoxyalkane (PFA). Of course, other polymers may be used. However, due to the wide variety of polymers available, it is not practical, nor necessary, to list alternative polymers herein. The filled polymer brush 36 may be either solid or foam and have its cleaning surface 92 configured in any manner suitable for the desired application. Examples of configurations of cleaning surface 92 suitable for use with the present invention are disclosed in U.S. Pat. No. 6,182,323 to Bahten, which is incorporated herein by reference.

In addition to brush 36, conductive path 84 may include various components of cleaning apparatus 20, e.g., brush support 56, various components of cleaning system 40, e.g., a chassis 96 (if present), and/or one or more wires 100, 102 within and/or outside the cleaning system. For example, if brush support 56 includes at least one arm 104 and a spindle 108 comprising a conductive material and conductive bearings or electrical brushes (not shown) are present between the arm and spindle, the arm and the spindle may form part of conductive path 84. Then, wire 100 may be provided between arm and chassis, which may be wired to ground 88 by wire 102. Alternatively, one or more wires (not shown) may be run so as to essentially bypass certain components, e.g., arms 104 of brush support 56. Such wires may be necessary when the bypassed components are not conductive. Even if such components are conductive, bypass wires may be desirable. Of course, there are many ways to form conductive path 84. However, those skilled in the art will understand how these ways may be implemented. Therefore, alternatives need not be described herein in detail.

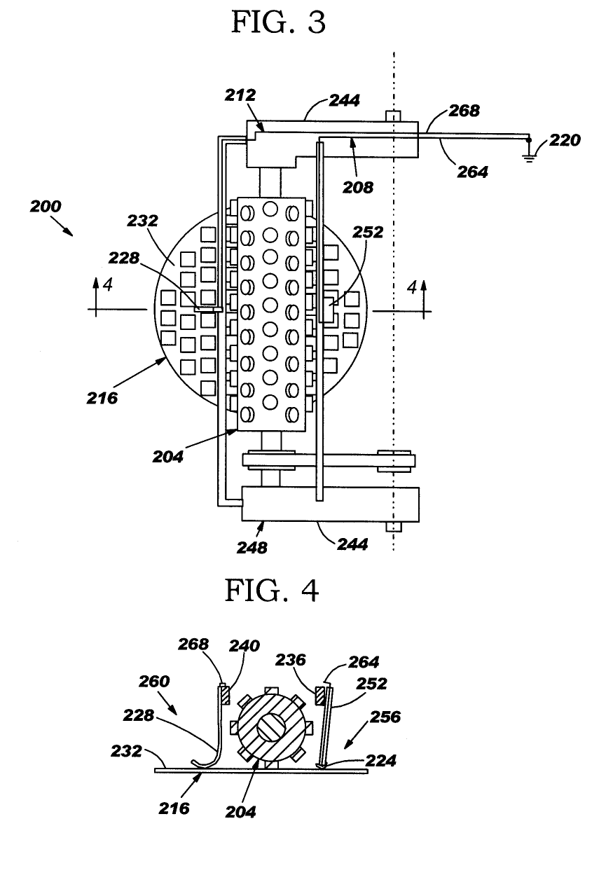

FIGS. 3 and 4 show an alternative cleaning apparatus 200 of the present invention that is similar to cleaning apparatus 20 of FIGS. 1 and 2, except that in the cleaning system of FIGS. 3 and 4, brush 204 need not be conductive. For example, brush 204 may be an ordinary non-conductive polyvinyl alcohol (PVA) brush, such as the brushes disclosed in the Bahten patent incorporated by reference above. Consequently, cleaning apparatus 200 of FIGS. 3 and 4 includes one or more conductive paths 208, 212 between article 216 and ground 220 that do not require brush 204 to be part thereof. Rather, each conductive path 208, 212 may include one or more contacts 224, 228 that contact article 216, e.g., on surface 232 being cleaned. Contacts 224, 228 may be supported by respective contact supports 236, 240, which may be attached to one or both arms 244 of brush support 248 or may be supported by another part of cleaning apparatus 200 or a part of the cleaning system (not shown) of which the cleaning apparatus may be part. Each contact 224, 228 may be an elongated flexible conductor contact 224 or may be a relatively stiff elongated conductor supported, e.g., by a resilient support (not shown) that biases the contact into contact with article 216. Alternatively, each contact 224, 228 may be of a non-elongated type (contact 224) supported by one or more members 252 extending substantially toward article 216. Member 252 may be flexible or otherwise resilient or resiliently supported so as to bias contact 228 into contact with article 216. In the embodiment shown, member 252 is relatively stiff, but is pivotably attached to contact support 236. Each contact 224, 228 may be made of any suitable conductive material. Gold may be a good choice due to its resistance to oxidation, which can degrade the electrical contact between article 216 and contacts 224, 228.

Brush 204 may be considered to have a leading side 256 and a trailing side 260. Which side is which depends upon the relative movement between brush 204 and article 216. Leading side 256 is the side of brush 204 proximate the portion of article 216 yet to be cleaned by the brush, and trailing side 260 is the side proximate the portion of the article just cleaned as one or both of the brush and article are moved relative to one another. In this connection, contacts 224, 228 may be provided on one, the other or both of leading side 256 and trailing side 260. In some applications, it may be desirable to have one or more contacts 224, 228 on each of leading and trailing sides 256, 260 so that at least one contact is in contact with article 216 while brush 204 is engaged with surface 232.

Although only one contact 224, 228 is shown on each of leading side 256 and trailing side 260, respectively, more than one contact may be present on each side. For example, each contact support 236, 240 may support a number of contacts (not shown) spaced from one another along the longitudinal direction of that contact support, generally forming a comb-like configuration of contacts. The location(s) of the one or more contacts 224, 228 may be determined based upon the shape of article 216. For example, when article 216 is a circular wafer, it may be preferable to locate contacts 224, 228 so that they are aligned with the diameter of the article that is parallel to the direction of relative movement between brush 204 and article 216. When this is done, the time of contact between article 216 and each contact 224, 228 is maximized.

Similar to cleaning apparatus 20 of FIGS. 1 and 2, conductive paths 208, 212 of cleaning apparatus 200 of FIGS. 3 and 4 from contacts 224, 228 to ground 220 may comprise components of the cleaning apparatus, such as contact supports 236, 240 and arms 244, among others, and components of the cleaning system of which the cleaning apparatus may be part, if these components comprise a conductive material. Alternatively, other conductors, such as wires 264, 268, may be run to bypass non-conductive components (or conductive components in some designs).

Although the invention has been described and illustrated with respect to several exemplary embodiments thereof, it should be understood by those skilled in the art that the foregoing and various other changes, omissions and additions may be made therein and thereto, without parting from the spirit and scope of the present invention defined by the appended claims.

1. An apparatus for removing contaminants from a surface of an article that may have a static electrical charge thereon, the apparatus being operatively configured for electrically connecting to an electrical ground, the apparatus comprising:
(a) a cleaning member operatively configured to remove at least some of the contaminants; and
(b) an electrically-conductive path extending from the article to the ground when the apparatus is connected to the electrical ground.

2. An apparatus according to claim 1, wherein said cleaning member comprises a brush.

3. An apparatus according to claim 2, wherein said brush comprises an electrically conductive material.

4. An apparatus according to claim 3, wherein said brush comprises a polymer filled with an electrically-conductive material.

5. An apparatus according to claim 4, wherein said brush comprises a carbon-filled perfluoroalkoxyalkane.

6. An apparatus according to claim 1, wherein said cleaning member is part of said electrically-conductive path.

7. An apparatus according to claim 6, wherein said cleaning member is a rotational brush.

8. An apparatus according to claim 1, wherein said electrically-conductive path includes at least one contact that engages the article at a location spaced from said cleaning member during at least a portion of the time said cleaning member is engaged with the article.

9. An apparatus according to claim 8, wherein said cleaning member has a leading side and a trailing side and said at least one contact is located proximate one of said leading side and said trailing side.

10. A method of removing contaminants from a surface of an article that may have a static electrical charge thereon, comprising the steps of:
(a) cleaning the surface of the article with a cleaning member so as to remove at least some of the contaminants; and
(b) during at least part of the time that step (a) is performed, contacting the article with a conductive member connected to an electrical ground.

11. A method according to claim 10, wherein said cleaning member is electrically conductive and step (b) includes contacting said cleaning member with the article.

12. A method according to claim 10, wherein step (a) includes contacting the surface with said cleaning member.

13. A method according to claim 12, wherein step (a) includes brushing the surface with said cleaning member.

14. A method according to claim 13, wherein step (a) includes rotating said cleaning member at least during the time said cleaning member is in contact with the surface.

15. A method according to claim 10, wherein step (b) includes contacting the article with at least one contact spaced from said cleaning member.

16. A method according to claim 15, wherein step (b) includes contacting said at least one contact with said surface.

17. A system for removing contaminants from a surface, comprising:
(a) an electronic article and having a surface;
(b) a cleaning member operatively configured to remove contaminants from said surface;
(c) an electrical ground; and
(d) an electrically-conductive path extending from said article to said ground.

18. A system according to claim 17, wherein said cleaning member comprises a rotational brush.

19. A system according to claim 18, wherein said rotational brush is part of said electrically-conductive path.

20. A system according to claim 17, wherein said electrically-conductive path includes at least one contact that engages said electronic article at a location spaced from said cleaning member during at least a portion of the time said cleaning member is engaged with said electronic article.
